(19) United States
(12) Patent Application Publication
(10) Pub. No.: US 2023/0247384 A1
(43) Pub. Date: Aug. 3, 2023

(54) INFORMATION PROCESSING DEVICE, OUTPUT CONTROL METHOD, AND PROGRAM

(71) Applicant: Sony Group Corporation, Tokyo (JP)

(72) Inventors: Koyuru Okimoto, Tokyo (JP); Toru Nakagawa, Chiba (JP); Masashi Fujihara, Kanagawa (JP)

(73) Assignee: Sony Group Corporation, Tokyo (JP)

(21) Appl. No.: 18/011,829

(22) PCT Filed: Jun. 18, 2021
(86) PCT No.: PCT/JP2021/023152

§ 371 Date: Dec. 20, 2022

(30) Foreign Application Priority Data
Jul. 2, 2020 (JP) 2020-115136

(51) Int. Cl. H04S 7/00; H04R 5/033; H04S 1/00

(52) U.S. Cl. CPC H04S 7/304; H04R 5/033; H04S 1/007; H04S 2400/11; H04S 2420/01

(57) ABSTRACT

The present feature relates to an information processing device, an output control method, and a program that allow a sense of distance about a sound source to be appropriately reproduced.

An information processing device according to the present feature causes a speaker provided in a listening space to output sound of a prescribed sound source which constitutes the audio of a content and an output device for each listener to output sound of a virtual sound source different from the prescribed sound source, wherein the sound of the virtual sound source is generated by processing using a transfer function corresponding to a sound source position. The present disclosure is applicable to an acoustic processing system in a movie theater.

### TECHNICAL FIELD

The present feature particularly relates to an information processing device, an output control method, and a program that allow a sense of distance about a sound source to be appropriately reproduced.

### BACKGROUND ART

There is a technique for reproducing a sound image in headphones three-dimensionally using a head-related transfer function (HRTF) which mathematically expresses how a sound travels from the sound source to the ear.

For example, PTL 1 discloses a technique for reproducing stereophonic sound using HRTFs measured with a dummy head.

### CITATION LIST

### Patent Literature

[PTL 1]

JP 2009-260574 A

### SUMMARY

### Technical Problem

While a sound image can be reproduced three-dimensionally using HRTFs, a sound image with a changing distance, for example a sound approaching the listener or a sound moving away from the listener cannot be reproduced.

The present feature has been made in view of the foregoing and allows a sense of distance about a sound source to be appropriately reproduced.

### Solution to Problem

An information processing device according to one aspect of the present feature includes an output control unit configured to cause a speaker provided in a listening space to output sound of a prescribed sound source which constitutes the audio of a content and an output device for each listener to output sound of a virtual sound source different from the prescribed sound source, wherein the sound of the virtual sound source is generated by processing using a transfer function corresponding to a sound source position.

In one aspect of the present feature, a speaker provided in a listening space outputs the sound of a prescribed sound source which constitutes the audio of a content and an output device for each listener to output the sound of a virtual sound source different from the prescribed sound source, wherein the sound of the virtual sound source is generated by processing using a transfer function corresponding to a sound source position.

### BRIEF DESCRIPTION OF DRAWINGS

FIG. 1 illustrates an exemplary configuration of an acoustic processing system according to an embodiment of the present feature.

FIG. 2 is a view for illustrating the principle of sound image localization processing.

FIG. 3 is an external view of an earphone.

FIG. 4 is a view of an exemplary output device.

FIG. 5 illustrates exemplary HRTFs stored in an HRTF database.

FIG. 5 illustrates exemplary HRTFs stored in an HRTF database.

FIG. 7 is a view for illustrating an example of how sound is reproduced.

FIG. 8 is a plan view of an exemplary layout of real speakers in a movie theater.

FIG. 9 is a view for illustrating the concept of sound sources in the movie theater.

FIG. 10 is a view of an example of the audience in the movie theater.

FIG. 11 is a diagram of an exemplary configuration of an acoustic processing device.

FIG. 12 is a flowchart for illustrating reproducing processing by the acoustic processing device having the configuration shown in FIG. 11.

FIG. 13 is a view of an exemplary dynamic object.

FIG. 14 is a diagram of an exemplary configuration of an acoustic processing device.

FIG. 15 is a flowchart for illustrating reproducing processing by the acoustic processing device having the configuration shown in FIG. 14.

FIG. 16 is a view of an exemplary dynamic object.

FIG. 17 is a diagram of an exemplary configuration of an acoustic processing device.

FIG. 18 illustrates examples of gain adjustment.

FIG. 19 is a view of exemplary sound sources.

FIG. 20 is a diagram of an exemplary configuration of an acoustic processing device.

FIG. 21 is a diagram of an exemplary configuration of an acoustic processing device.

FIG. 22 is a flowchart for illustrating reproducing processing by the acoustic processing device having the configuration shown in FIG. 21.

FIG. 23 is a view of an exemplary configuration of a hybrid-type acoustic system.

FIG. 24 is a view of an exemplary installation position of on-board speakers.

FIG. 25 is a view of an exemplary virtual sound source.

FIG. 26 is a view of an exemplary screen.

FIG. 27 is a block diagram of an exemplary configuration of a computer.

### DESCRIPTION OF EMBODIMENTS

Hereinafter, a mode for carrying out the present feature will be described. The description will be made in the following order.

1. Sound image localization processing

2. Multi-layer HRTF

3. Exemplary application of acoustic processing system

4. Modifications

5. Other examples

### Sound Image Localization Processing

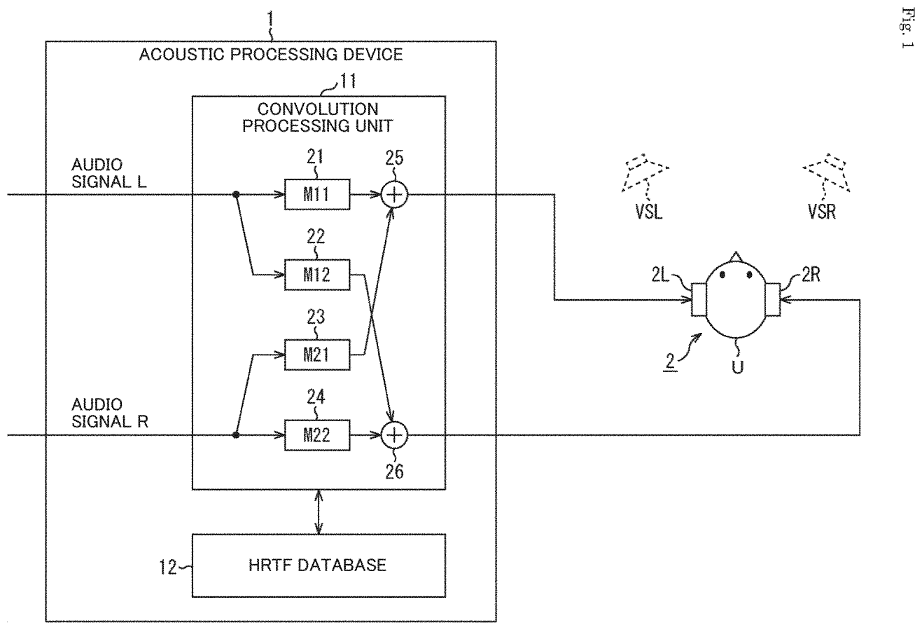

FIG. 1 illustrates an exemplary configuration of an acoustic processing system according to an embodiment of the present feature.

The acoustic processing system shown in FIG. 1 includes an acoustic processing device 1 and earphones (inner-ear headphones) 2 worn by a user U as an audio listener. The left unit 2L which forms the earphone 2 is worn on the left ear of the user U, and the right unit 2R is worn on the right ear.

The acoustic processing device 1 and the earphones 2 are connected wired through cables or wirelessly through a prescribed communication standard such as a wireless LAN or Bluetooth (registered trademark).

Communication between the acoustic processing device 1 and the earphones 2 may be carried out via a portable terminal such as a smart phone carried by the user U. Audio signals obtained by reproducing a content are input to the acoustic processing device 1.

For example, audio signals obtained by reproducing a movie content are input to the acoustic processing device 1. The movie audio signals include various sound signals such as voice, background music, and ambient sound. The audio signal includes an audio signal L as a signal for the left ear and an audio signal R as a signal for the right ear.

The kinds of audio signals to be processed in the acoustic processing system are not limited to the movie audio signals. Various types of sound signals such as sound obtained by playing a music content, sound obtained by playing a game content, voice messages, and electronic sound such as chimes and buzzer sound is used as a processing target. In the following description, sound heard by user U is audio sound, while the user U hears other kinds of sound than audio sound. The various kinds of sound described above such as sound in a movie, sound obtained by playing a game content are described here as audio sound. The various kinds of sound described above, such as sound in a movie, sound obtained by playing a game content are described here as audio sound.

The acoustic processing device 1 processes input audio signals as if the movie sound being heard has been emitted from the positions of a left virtual speaker VSL and a right virtual speaker VSR indicated by the dashed lines in the right part of FIG. 1. In other words, the acoustic processing device 1 localizes the sound image of sound output from the earphones 2 so that the sound image is perceived as sound from the left virtual speaker VSL and the right virtual speaker VSR.

When the left virtual speaker VSL and the right virtual speaker VSR are not distinguished, they are collectively referred to as virtual speakers VS. In the example in FIG. 1, the position of the virtual speakers VS is in front of the user U and the number of the virtual speakers is set to two, but the position and number of the virtual sound sources corresponding to the virtual speakers VS may be changed, as appropriate, as the movie progresses.

The convolution processing unit 11 of the acoustic processing device 1 subjects the audio signals to sound image localization processing to output such audio sound, and the audio signals L and R are output to the left unit 2L and the right unit 2R, respectively.

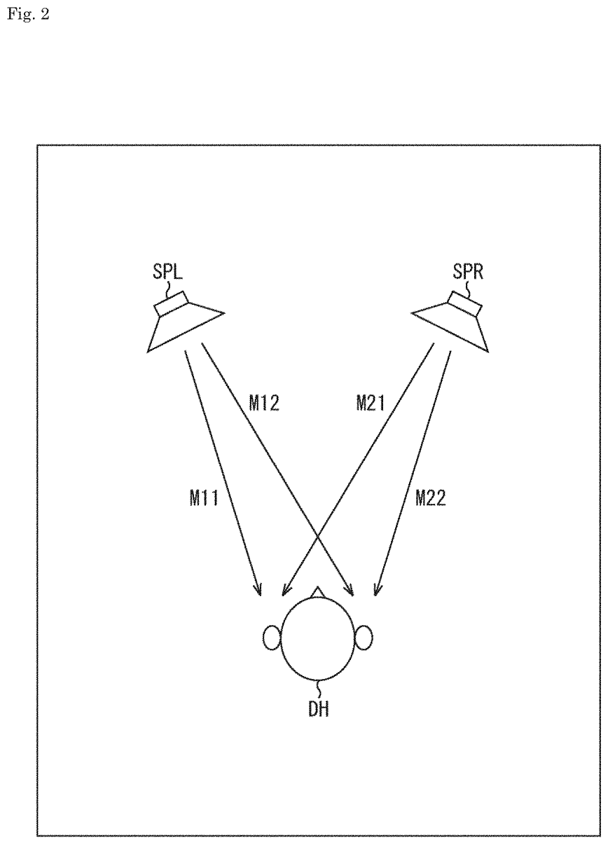

FIG. 2 is a view for illustrating the principle of sound image localization processing.

In a prescribed reference environment, the position of a dummy head DH is set as the listener's position. Microphones are installed in the left and right ear parts of the dummy head DH. A left real speaker SPL and a right real speaker SPR are provided at the positions of the left and right virtual speakers where a sound image is to be localized. The real speakers refer to speakers that are actually provided.

Sound output from the left real speaker SPL and the right real speaker SPR is collected at the ear parts of the dummy head DH, and a transfer function (HRTF: Head-related transfer function) representing change in the characteristic of the sound between the sound output from the left and right real speakers SPL and SPR and the sound arriving at the ear parts of the dummy head DH is measured in advance. The transfer function may be measured by having a person actually seated and placing microphones near the person's ears instead of using the dummy head DH.

Let us assume that the sound transfer function from the left real speaker SPL to the left ear of the dummy head DH is M11 and the sound transfer function from the left real speaker SPL to the right ear of the dummy head DH is M12, as shown in FIG. 2. Also, assume that the sound transfer function from the right real speaker SPR to the left ear of the dummy head DH is M21, and the sound transfer function from the right real speaker SPR to the right ear of the dummy head DH is M22.

An HRTF database 12 in FIG. 1 stores information on HRTFs (information on coefficients representing the HRTFs) as the transfer functions measured in advance in this way. The HRTF database 12 functions as a storage unit that stores the HRTF information.

A convolution processing unit 11 reads and obtains, from the HRTF database 12, pairs of coefficients of HRTFs according to the positions of the left virtual speaker VSL and the right virtual speaker VSR at the time of output of movie sounds, and sets the filter coefficients to filters 21 to 24.

The filter 21 performs filtering processing to apply the transfer function M11 to an audio signal L and outputs the filtered audio signal L to an addition unit 25. The filter 22 performs filtering processing to apply the transfer function M12 to an audio signal L and outputs the filtered audio signal L to an addition unit 26.

The filter 23 performs filtering processing to apply the transfer function M21 to an audio signal R and outputs the filtered audio signal R to the addition unit 25. The filter 24 performs filtering processing to apply the transfer function M22 to an audio signal R and outputs the filtered audio signal R to the addition unit 26.

The addition unit 25 as an addition unit for the left channel, adds the audio signal L filtered by the filter 21 and the audio signal R filtered by the filter 23 and outputs the audio signal after the addition. The audio signal after the addition is transmitted to the earphones 2, and a sound corresponding to the audio signal is output from the left unit 2L of the earphones 2.

The addition unit 26 as an addition unit for the right channel, adds the audio signal L filtered by the filter 22 and the audio signal R filtered by the filter 24 and outputs the audio signal after the addition. The audio signal after the addition is transmitted to the earphones 2, and a sound corresponding to the audio signal is output from the right unit 2R of the earphones 2.

In this way, the acoustic processing device 1 subjects the audio signal to convolution processing using an HRTF according to the position where a sound image is to be localized, and the sound image of the sound from the earphones 2 is localized so that the user U perceives the sound image has been emitted from the virtual speakers VS.

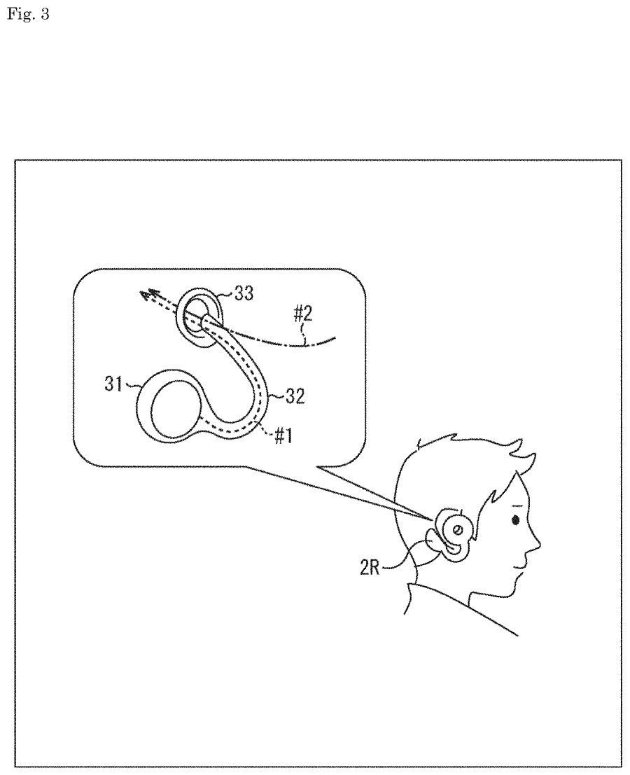

FIG. 3 is an external view of an earphone 2.

As shown enlarged in the balloon in FIG. 3, the right unit 2R includes a driver unit 31 and a ring-shaped mounting part 33 which are joined together via a U-shaped sound conduit 32. The right unit 2R is mounted by pressing the mounting part 33 around the outer ear hole so that the right ear is sandwiched the mounting part 33 and the driver unit 31.

The left unit 2L has the same structure as the right unit 2R. The left unit 2L and the right unit 2R are connected wired or wirelessly.

The driver unit 31 of the right unit 2R receives an audio signal transmitted from the acoustic processing device 1 and generates sound according to the audio signal and causes sound corresponding to the audio signal to be output from the tip of the sound conduit 32 as indicated by the arrow #1. A hole is formed at the junction of the sound conduit 32 and the mounting part 33 to output sound toward the outer ear hole.

The mounting part 33 has a ring shape. Together with the sound of a content output from the tip of the sound conduit 32, the ambient sound also reaches the outer ear hole as indicated by the arrow #2.

In this way, the earphones 2 are so-called open-ear (open) earphones that do not block the ear holes. A device other than earphones 2 may be used as an output device used for listening to the sound of the content.

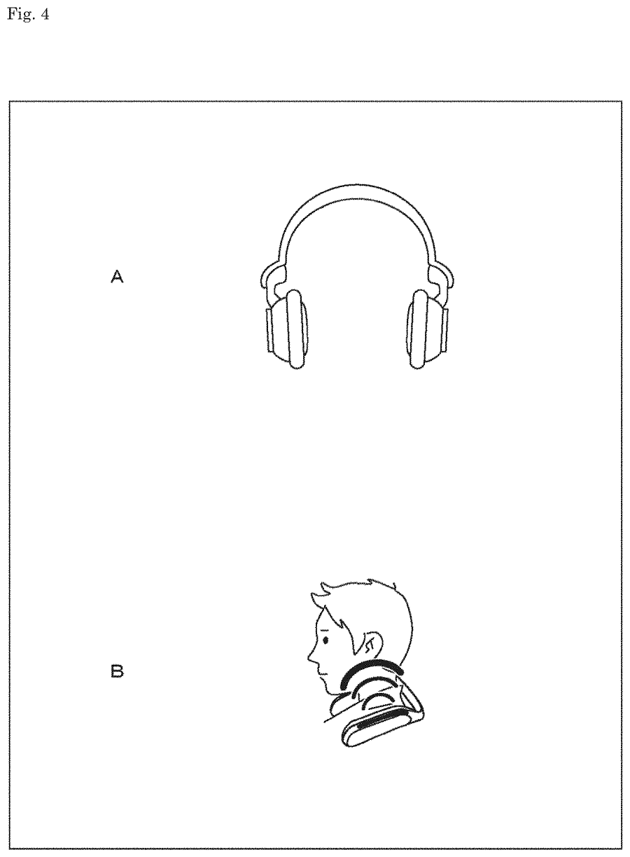

FIG. 4 is a view of an exemplary output device.

As an output device used for listening to the sound of a content, sealed type headphones (over-ear headphones) as shown in FIG. 4 at A are used. For example, the headphones shown in FIG. 4 at A are headphones with the function of capturing outside sound.

Shoulder-mounted neckband speakers as shown in FIG. 4 at B are used as an output device used for listening to the sound of a content. The left and right units of the neckband speakers are provided with speakers, and sound is output toward the user's ears.

Any of output devices capable of capturing outside sound such as the earphones 2, the headphones in FIG. 4 at A and the neckband speakers in FIG. 4 at B can be used to listen to the sound of a content.

### Multi-Layer HRTF

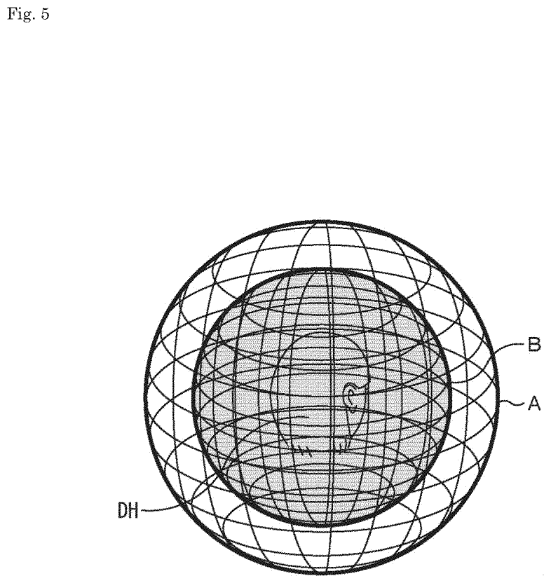

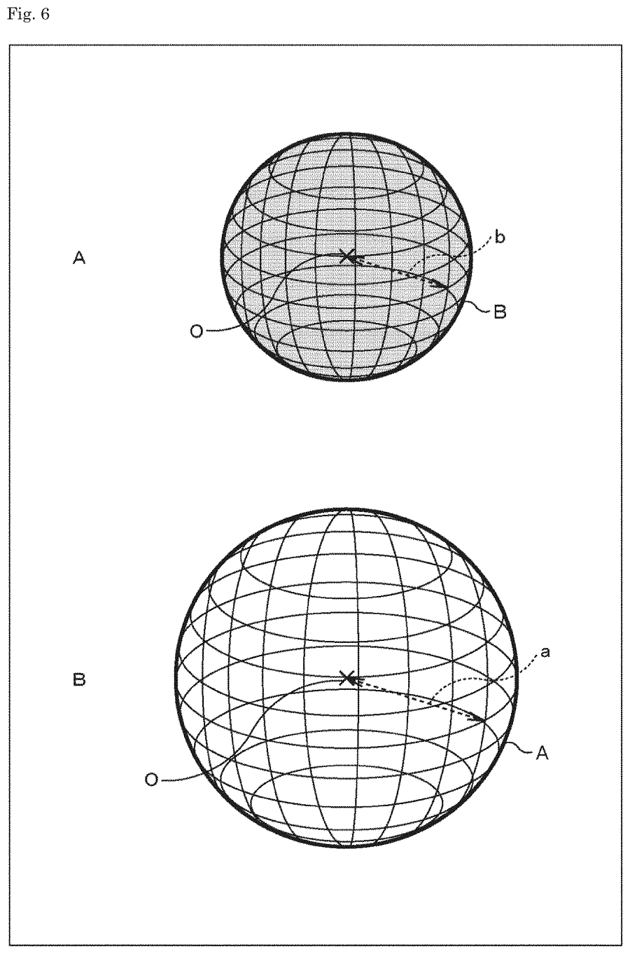

FIGS. 5 and 6 illustrate exemplary HRTFs stored in the HRTF database 12.

The HRTF database 12 stores HRTF information on each of the sound sources arranged in a full sphere shape centered on the position of the reference dummy head DH.

As shown separately in FIG. 6 at A and B, a plurality of sound sources are placed in positions a distance a apart from the position O of the dummy head DH as the center in a full sphere shape, while a plurality of sound sources are placed in positions a distance b (a>b) apart from the center in a full sphere shape. In this way, layers of sound sources positioned the distance b apart from the position O as the center and layers of sound sources positioned the distance a apart from the center are provided. For example, sound sources in the same layer are equally spaced.

An HRTF at each of the sound sources arranged in this way is measured, so that the HRTF layer B and the HRTF layer A as HRTF layers in the full sphere shape are formed. The HRTF layer A is the outer HRTF layer, and the HRTF layer B is the inner HRTF layer.

In FIGS. 5 and 6, for example, the intersections of the latitudes and longitudes each represent a sound source position. The HRTF of a certain sound source position is obtained by measuring an impulse response from the position at the positions of the ears of the dummy head DH and expressing the result on the frequency axis.

The following methods can be used to obtain HRTFs.

1. A real speaker is placed at each sound source position and acquire an HRTF by a single measurement.

2. Real speakers are placed at different distances and acquire HRTFs by multiple measurements.

3. Acoustic simulation is carried out to obtain an HRTF.

4. Measurement is carried out using real speakers for one of the HRTF layers and estimation is carried out for the other HRTF layer.

5. Estimation from ear images is carried out using an inference model prepared in advance by machine learning.

As the multiple HRTF layers are prepared, the acoustic processing device 1 can switch the HRTF used for sound image localization processing (convolution processing) between the HRTFs in the HRTF layer A and the HRTF layer B. Sound approaching or moving away from the user U may be reproduced by switching between the HRTFs.

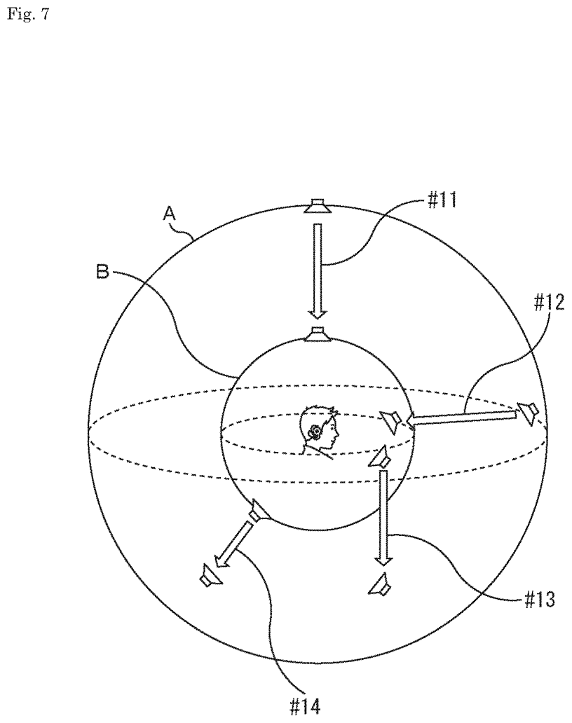

FIG. 7 is a view for illustrating an example of how sound is reproduced.

The arrow #11 represents the sound of an object above the user U falling, and the arrow #12 represents the sound of an approaching object in front of user U. These kinds of sound are reproduced by switching the HRTF used for sound image localization processing from an HRTF in the HRTF layer A to an HRTF in the HRTF layer B.

The arrow #13 represents the sound of an object near user U falling at the user's feet, and the arrow #14 represents the sound of an object behind the user U at the user's feet moving away from the user. These sounds are reproduced by switching the HRTF used for sound image localization processing from the HRTF at the HRTF layer B to the HRTF at the HRTF layer A.

In this way, by switching the HRTF used for sound image localization processing from one HRTF layer to another HRTF layer, the acoustic processing device 1 can reproduce various kinds of sound that travel in the depth-wise direction, which cannot be reproduced for example by conventional VAD (Virtual Auditory Display) systems.

In addition, since HRTFs are prepared for the sound source positions arranged in the full sphere shape, not only sound that travels above the user U, but also sound that travels below the user U can be reproduced.

In the foregoing, the shape of the HRTF layers is a full sphere shape (sphere-shaped), but the shape may be a semi-spherical shape or a different shape other than a sphere. For example, the sound sources may be arranged in an elliptical or cubic shape to surround the reference position, so that multiple HRTF layers may be formed. In other words, instead of arranging all of the HRTF sound sources that form one HRTF layer at the same distance from the center, the sound sources may be arranged at different distances.

Although the outer HRTF layer and the inner HRTF layer are assumed to have the same shape, the layers may have different shapes.

The multi-layered HRTF layer may include two layers, but three or more HRTF layers may be provided. The spacing between the HRTF layers may be the same or different.

Although the center position of the HRTF layer is assumed to be the position of the user U, the HRTF layer may be set with the center position as a position shifted horizontally and vertically from the position of the user U.

When listening only to sound reproduced using the multiple HRTF layers, an output device such as headphones without an external sound capturing function can be used.

In other words, the following combinations of output devices are available.

1. Sealed headphones are used as the output device for both the sound reproduced using the HRTFs in the HRTF layer A and the sound reproduced using the HRTFs in the HRTF layer B.

2. Open-type earphones (earphones 2) are used as the output device for both the sound reproduced using the HRTFs in the HRTF layer A and the sound reproduced using the HRTFs in the HRTF layer B.

3. Real speakers are used as the output device for the sound reproduced using the HRTFs in the HRTF layer A, and open-type earphones are used as the output device for the sound reproduced using the HRTFs in the HRTF layer B.

### Exemplary Application of Acoustic Processing Systems

### Movie Theater Acoustic System

The acoustic processing system shown in FIG. 1 is applied, for example, to a movie theater acoustic system. Not only the earphones 2 worn by each user seated in a seat as audience but also real speakers provided in prescribed positions in the movie theater are used in order to output the sound of the movie.

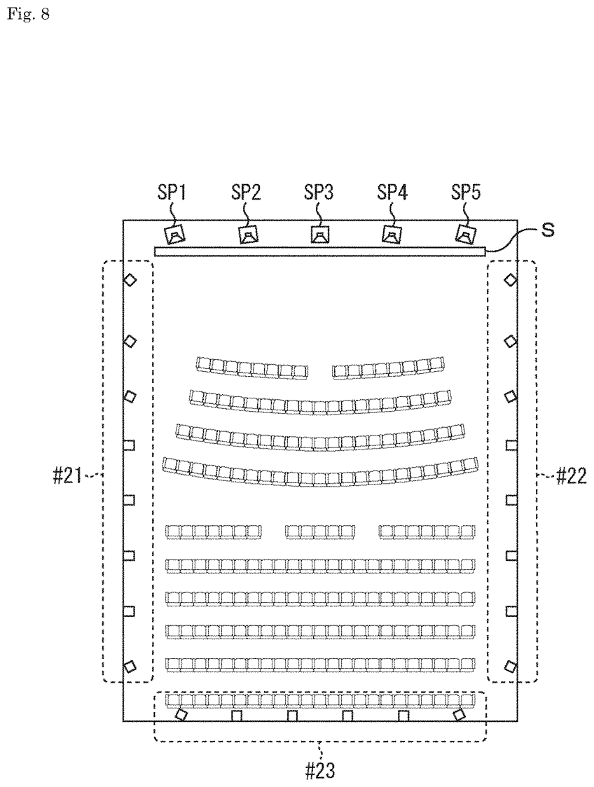

FIG. 8 is a plan view of an exemplary layout of real speakers in a movie theater.

As shown in FIG. 8, real speakers SP1 to SP5 are provided behind a screen S provided at the front of the movie theater. Real speakers such as subwoofers are also provided behind the screen S.

As indicated by the dashed lines #21, #22, and #23, real speakers are also provided on the left and right walls and the rear wall of the movie theater, respectively. In FIG. 8, the small regular square rectangles shown along the straight lines representing the wall surfaces represent the real speakers.

As described above, the earphones 2 can capture outside sound. Each of the users listens to sound output from the real speakers as well as sound output from the earphones 2.

The output destination of sound is controlled according to the type of a sound source, so that for example sound from a certain sound source is output from the earphones 2 and sound from another sound source is output from the real speakers.

For example, the voice sound of a character included in a video image is output from the earphones 2, and ambient sound is output from the real speakers.

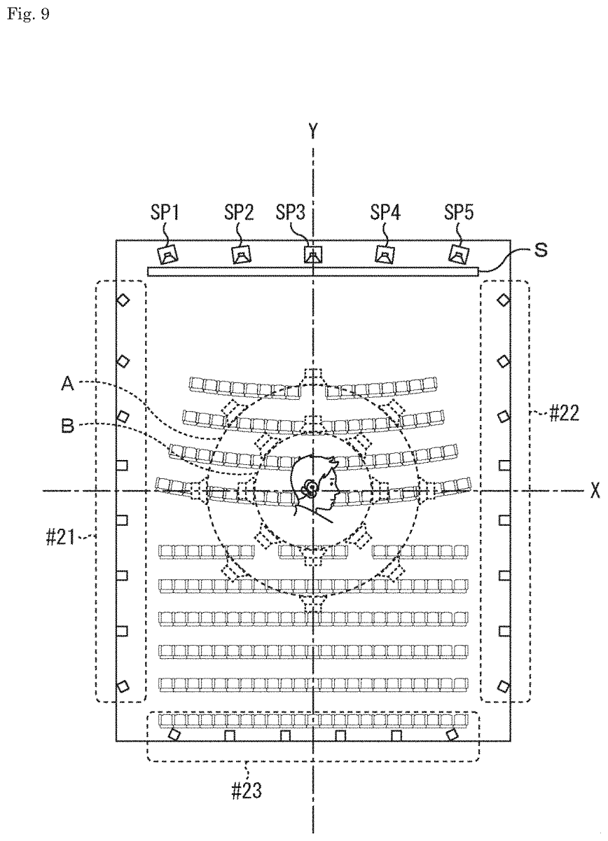

FIG. 9 is a view for illustrating the concept of sound sources in the movie theater.

As shown in FIG. 9, virtual sound sources reproduced by multiple HRTF layers will be provided as sound sources around the user, along with real speakers provided behind the screen S and on the wall surface. The speakers indicated by the dashed lines along circles indicating the HRTF layers A and B in FIG. 9 represent the virtual sound sources reproduced according to HRTFs. FIG. 9 illustrates the virtual sound source centered on the user seated at the origin position of the coordinates set in the movie theater, but the virtual sound source is reproduced around each of the users seated at other positions in the same way using the multiple HRTF layers.

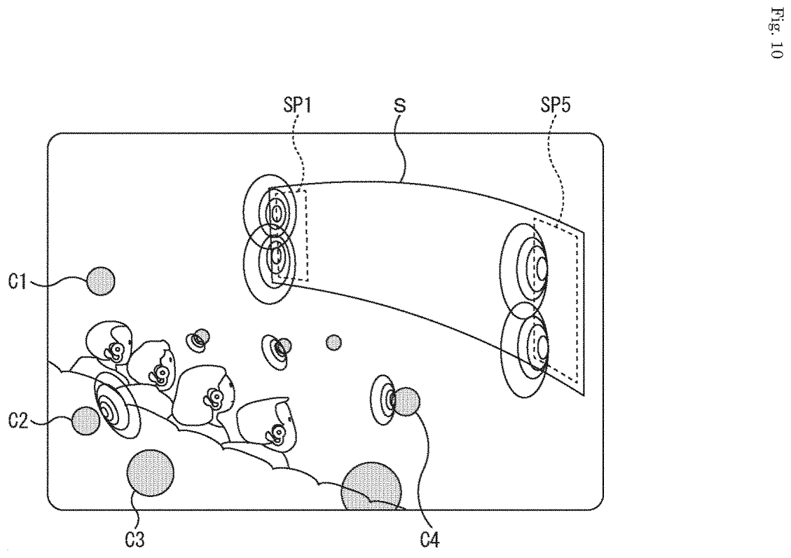

In this way, as shown in FIG. 10, each of the users watching a movie while wearing the earphones 2 thus can hear the sound of the virtual sound sources reproduced on the basis of the HRTFs along with the ambient sound and other sound output from the real speakers including the real speakers SP1 and SP5.

In FIG. 10, circles in various sizes around the user wearing the earphones 2 including colored circles C1 to C4 represent virtual sound sources to be reproduced on the basis of the HRTFs.

In this way, the acoustic processing system shown in FIG. 1 realizes a hybrid type acoustic system in which sound is output using the real speakers provided in the movie theater and the earphones 2 worn by each of the users.

As the open-type earphones 2 and the real speakers are combined, sound optimized for each of the audience members and common sound heard by all the audience members can be controlled. The earphones 2 are used to output the sound optimized for each of the audience members, and the real speakers are used to output the common sound heard by all the audience members.

Hereinafter, sound output from the real speakers will be referred to as the sound of the real sound sources, as appropriate, in the sense that the sound is output from the speakers that are actually provided. Sound output from the earphones 2 is the sound of the virtual sound sources, since the sound is the sound of the sound sources virtually set on the basis of the HRTFs.

### Basic Configuration and Operation of Acoustic Processing Device 1

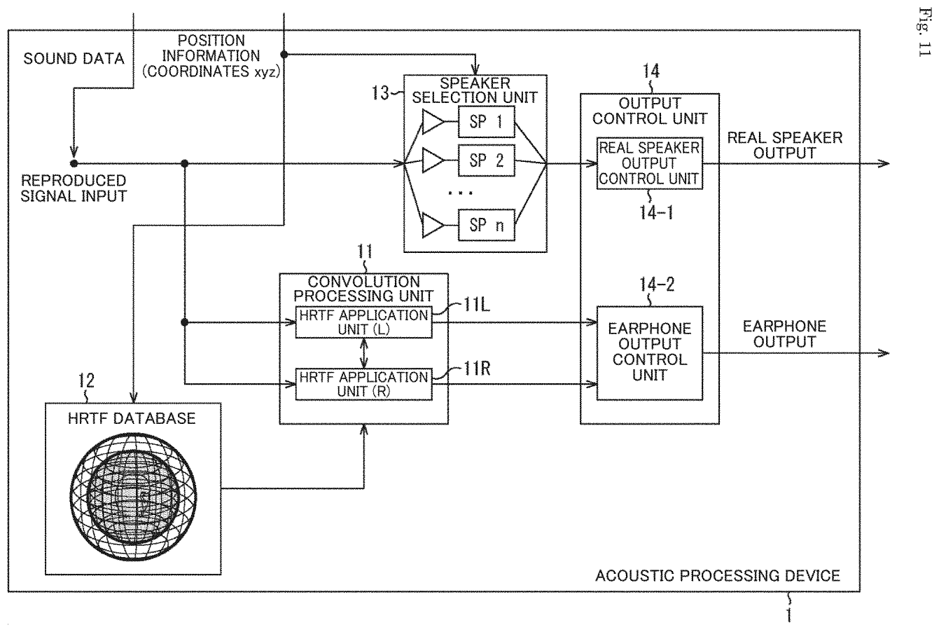

FIG. 11 is a diagram of an exemplary configuration of an acoustic processing device 1 as an information processing unit that implements a hybrid type acoustic system.

Among the elements shown in FIG. 11, the same elements as those described above with reference to FIG. 1 will be denoted by the same reference characters. Redundant description will be appropriately omitted.

The acoustic processing device 1 includes a convolution processing unit 11, the HRTF database 12, a speaker selection unit 13, and an output control unit 14. Sound source information, as information on each sound source is input to the acoustic processing device 1. The sound source information includes sound data and position information.

The sound data, as sound waveform data, is supplied to the convolution processing unit 11 and the speaker selection unit 13. The position information represents the coordinates of the sound source position in a three-dimensional space. The position information is supplied to the HRTF database 12 and the speaker selection unit 13. In this way, for example object-based audio data as information on each sound source including a set of sound data and position information is input to the acoustic processing device 1.

The convolution processing unit 11 includes an HRTF application unit 11L and an HRTF application unit 11R. For the HRTF application unit 11L and the HRTF application unit 11R, a pair of HRTF coefficients (an L coefficient and an R coefficient) corresponding to a sound source position read out from the HRTF database 12 are set. The convolution processing unit 11 is prepared for each sound source.

The HRTF application unit 11L performs filtering processing to apply an HRTF to an audio signal L and outputs the filtered audio signal L to the output control unit 14. The HRTF application unit 11R performs filtering processing to apply an HRTF to an audio signal R and outputs the filtered audio signal R to the output control unit 14.

The HRTF application unit 11L includes the filter 21, the filter 22, and the addition unit 25 in FIG. 1 and the HRTF application unit 11R includes the filter 23, the filter 24, and the addition unit 26 in FIG. 1. The convolution processing unit 11 functions as a sound image localization processing unit that performs sound image localization processing by applying an HRTF to an audio signal to be processed.

The HRTF database 12 outputs, to the convolution processing unit 11, a pair of HRTF coefficients corresponding to a sound source position on the basis of position information. The HRTFs that form the HRTF layer A or the HRTF layer B are identified by the position information.

The speaker selection unit 13 selects a real speaker to be used for outputting sound on the basis of the position information. The speaker selection unit 13 generates an audio signal to be output from the selected real speaker and outputs the signal to the output control unit 14.

The output control unit 14 includes a real speaker output control unit 14-1 and an earphone output control unit 14-2.

The real speaker output control unit 14-1 outputs the audio signal supplied from the speaker selection unit 13 to the selected real speaker and the audio signal is output to the selected real speaker as the sound of the real sound source.

The earphone output control unit 14-2 outputs the audio signal L and the audio signal R supplied from the convolution processing unit 11 to the earphones 2 worn by each of the users and causes the earphones to output the sound of the virtual sound source.

A computer which implements the acoustic processing device 1 having such a configuration is provided for example at a prescribed position in a movie theater.

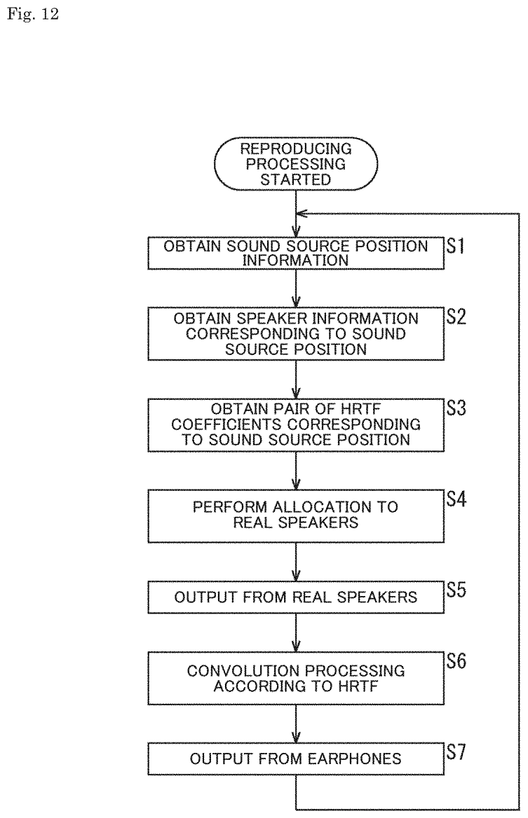

Referring to the flowchart in FIG. 12, the reproducing processing by the acoustic processing device 1 having the configuration shown in FIG. 11 will be described.

In step S1, the HRTF database 12 and the speaker selection unit 13 obtain position information on sound sources.

In step S2, the speaker selection unit 13 obtains speaker information corresponding to the positions of the sound sources. Information on the characteristics of the real speakers are acquired.

In step S3, the convolution processing unit 11 acquires pairs of HRTF coefficients read from the HRTF database 12 according to the positions of the sound sources.

In step S4, the speaker selection unit 13 allocates audio signals to the real speakers. The allocation of the audio signals is based on the positions of the sound sources and the positions of the installed real speakers.

In step S5, the real speaker output control unit 14-1 allocates the audio signals to the real speakers according to the allocation by the speaker selection unit 13 and causes sound corresponding to each of the audio signals to be output from the real speakers.

In step S6, the convolution processing unit 11 performs convolution processing to the audio signals on the basis of the HRTFs and outputs the audio signals after the convolution processing to the output control unit 14.

In step S7, the earphone output control unit 14-2 transmits the audio signals after the convolution processing to the earphones 2 to output the sound of the virtual sound sources.

The above processing is repeated for each sample from each sound source that constitutes the audio of the movie. In the processing of each sample, the pair of HRTF coefficients is updated as appropriate according to position information on the sound sources. The movie content includes video data as well as sound data. The video data is processed in another processing unit.

Through the processing, the acoustic processing device 1 can control the sound optimized for each of the audience members and the sound common among all the audience members, and reproduce the sense of distance about the sound sources appropriately.

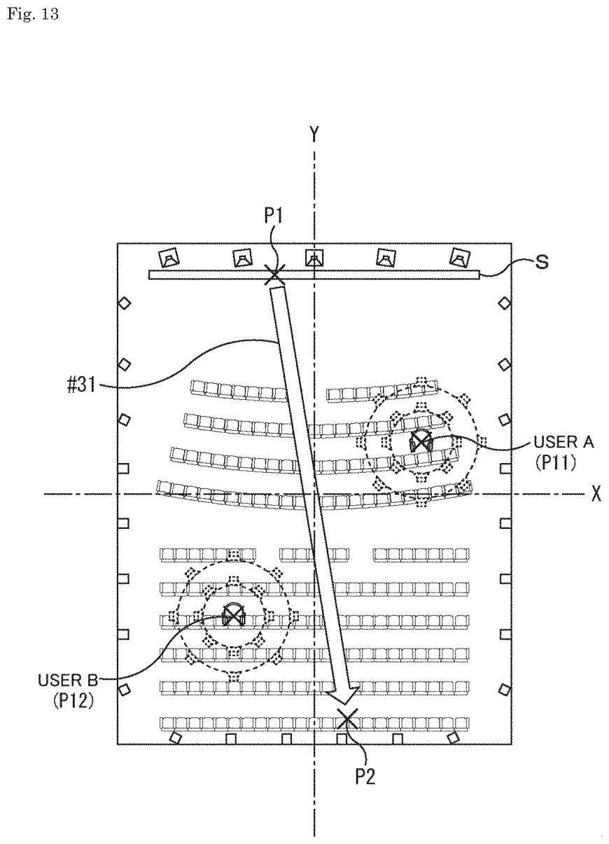

For example, if an object is assumed to move with reference to absolute coordinates in a movie theater as indicated by the arrow #31 in FIG. 13, the sound of the object is output from the earphones 2, so that the user experience can be changed depending on the seat position even for the same content.

In the example in FIG. 13, an object is set to move from position P1 on the screen S to position P2 at the rear of the movie theater. The position of the object in absolute coordinates at each timing is converted to a position with reference to the position of each user's seat, and an HRTF (an HRTF in the HRTF layer A or an HRTF in the HRTF layer B) corresponding to the converted position is used to perform sound image localization processing of the sound output from the earphones 2 of each of the users.

A user A seated at the position P11 on the front right side of the movie theater listens to sound output from the earphones 2, which causes the user to perceive as if the object moves diagonally to the left and backward. A user B seated at position P12 on the rear left side of the movie theater listens to the sound output from the earphones 2, and feels as if the object moves backward from the front diagonally to the right.

Using the multiple HRTF layers or using open type earphones and real speakers as audio output devices, the acoustic processing device 1 can carry out output control as follows.

1. Control that causes the earphones 2 to output the sound of a character in a video image and real speakers to output ambient sound.

In this case, the acoustic processing device 1 causes the earphones 2 to output the sound having a sound source position within a prescribed range from the character's position on the screen S.

2. Control that causes the earphones 2 to output sound existing in the hollow of the movie theater and the real speakers to output ambient sound included in a bed channel.

In this case, the acoustic processing device 1 causes the real speakers to output the sound of a sound source having a sound source position within a prescribed range from the position of the real speakers, and the earphones 2 to output the sound of a virtual sound source having a sound source position apart from the real speakers outside that range.

3. Control that causes the earphones 2 to output the sound of a dynamic object having a moving sound source position and the real speakers to output the sound of a static object having a fixed sound source position.

4. Control that causes the real speakers to output common sound to all audience members such as ambient sound and background music and the earphones 2 to output sound optimized for each of the users such as sound in different languages and sound having a sound source direction changed according to the seat position.

5. Control that causes the real speakers to output sound existing in a horizontal plane including the position where the real speakers are provided and the earphones 2 to output sound existing in a position vertically shifted from the above horizontal plane.

In this case, the acoustic processing device 1 causes the real speakers to output the sound of a sound source positioned at the same height as the height of the real speakers and the earphones 2 to output the sound of a virtual sound source having a sound source position at a different height from the height of the real speakers. For example, a prescribed height range based on the height of the real speakers is set as the same height as the real speakers.

6. Control that causes the real speakers to output the sound of an object existing in the movie theater and the earphones 2 to output the sound of an object existing at a position outside the walls of the movie theater or outside and above the ceiling.

In this way, the acoustic processing device 1 can perform various kinds of control that cause the real speakers to output the sound of a prescribed sound source that constitutes the audio of a movie and the earphones 2 to output the sound of a different sound source as the sound of a virtual sound source.

### Example 1 of Output Control

When the audio of a movie includes bed channel sound and object sound, real speakers may be used to output the bed channel sound and the earphones 2 may be used to output the object sound. In other words, real speakers are used to output the channel-based sound source and the earphones 2 are used to output the object-based virtual sound source.

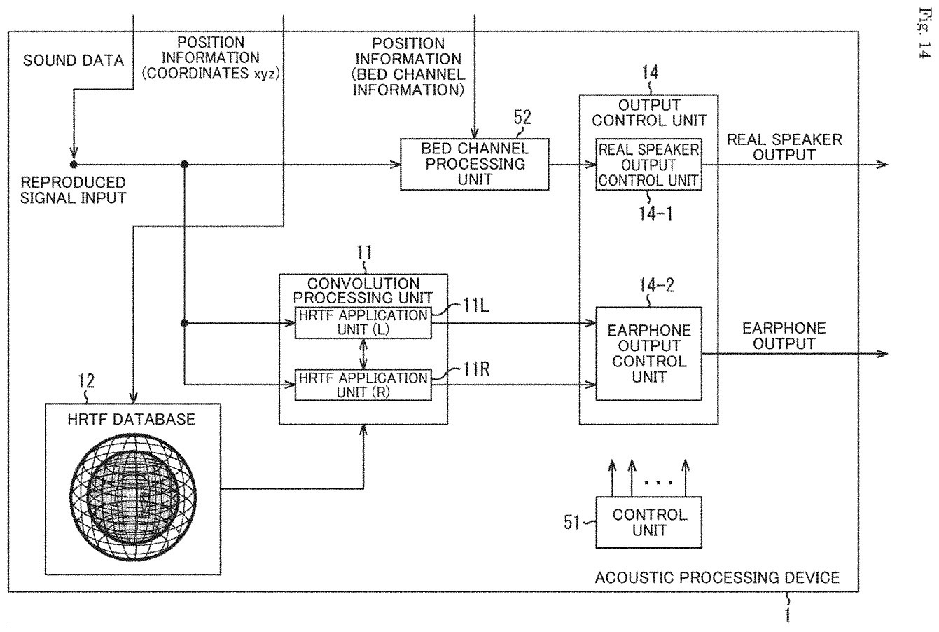

FIG. 14 is a diagram of an exemplary configuration of the acoustic processing device 1.

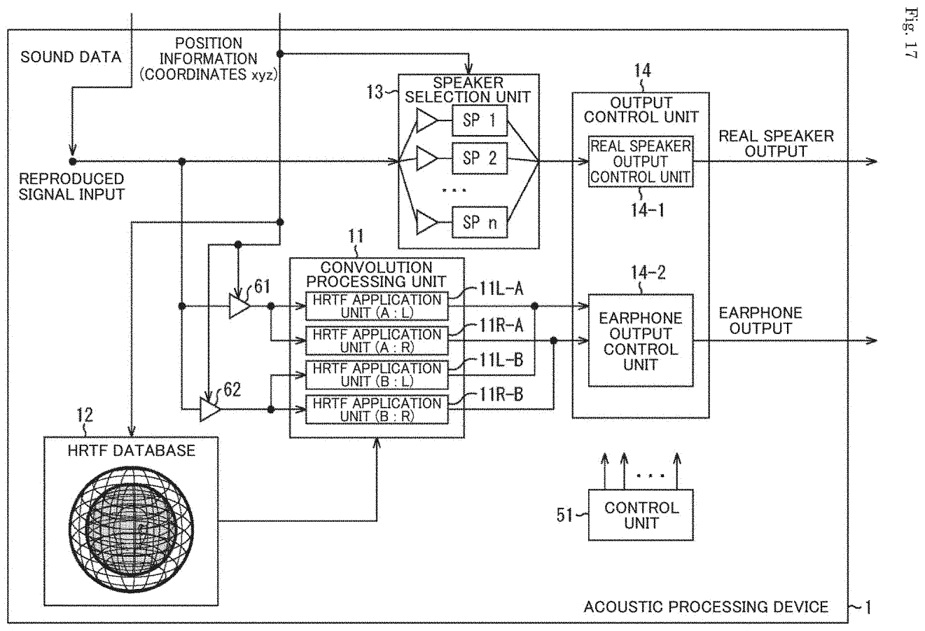

Among the elements shown in FIG. 14, the same elements as those described above with reference to FIG. 11 will be denoted by the same reference characters. The same description will not be repeated. The same applies to FIG. 17 to be described below.

The configuration shown in FIG. 14 is different from that shown in FIG. 11 in that a control unit 51 is provided and a bed channel processing unit 52 is provided instead of the speaker selection unit 13. Bed channel information is supplied to the bed channel processing unit 52, which indicates from which real speaker the sound of a sound source is to be output as the position information of the sound source.

The control unit 51 controls the operation of each part of the acoustic processing device 1. For example, on the basis of the attribute information of the sound source information input to the acoustic processing device 1, the control unit 51 controls whether to output the sound of an input sound source from the real speaker or from the earphones 2.

The bed channel processing unit 52 selects the real speakers to be used for sound output on the basis of the bed channel information. The real speaker used for outputting sound is identified from among the real speakers, Left, Center, Right, Left Surround, Right Surround, . . . .

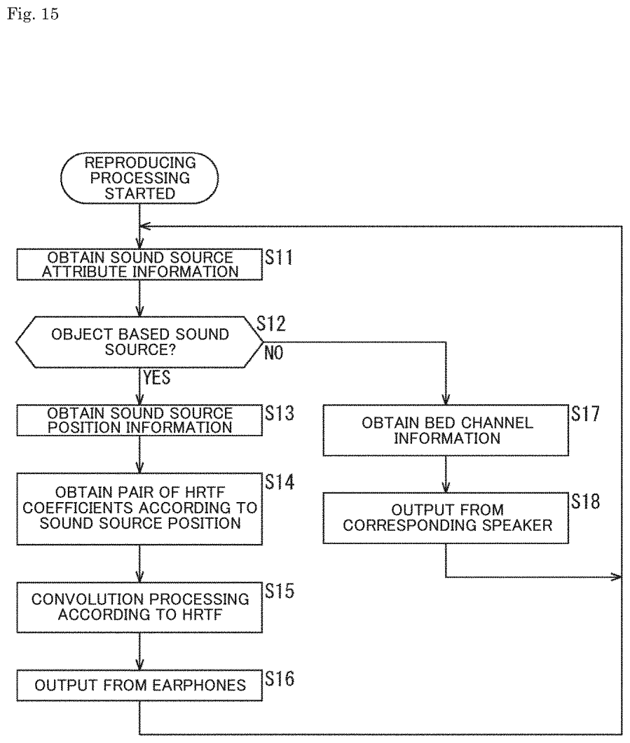

Referring to the flowchart in FIG. 15, the reproducing processing by the acoustic processing device 1 having the configuration shown in FIG. 14 will be described.

In step S11, the control unit 51 acquires attribute information on a sound source to be processed.

In step S12, the control unit 51 determines whether the sound source to be processed is an object-based sound source.

If it is determined in step S12 that the sound source to be processed is an object-based sound source, the same processing as the processing described with reference to FIG. 12 for outputting the sound of the virtual sound source from the earphones 2 is performed.

In other words, in step S13, the HRTF database 12 obtains the position information of the sound source.

In step S14, the convolution processing unit 11 acquires pairs of HRTF coefficients read from the HRTF database 12 according to the positions of the sound sources.

In step S15, the convolution processing unit 11 performs convolution processing on an audio signal from the object-based sound source and outputs the audio signal after the convolution processing to the output control unit 14.

In step S16, the earphone output control unit 14-2 transmits the audio signals after the convolution processing to the earphones 2 to output the sound of the virtual sound sources.

Meanwhile, if it is determined in step S12 that the sound source to be processed is not an object-based sound source but a channel-based sound source, then the bed channel processing unit 52 obtains bed channel information in step S17, and the bed channel processing unit 52 identifies the real speaker to be used for sound output based on the bed channel information.

In step S18, the real speaker output control unit 14-1 outputs the bed channel audio signal supplied by the bed channel processing unit 52 to the real speakers and causes the signals to be output as the sound of the real sound source.

After one sample of sound is output in step S16 or step S18, the process in and after step S11 is repeated.

A real speaker can be used to output not only the sound of a channel-based sound source but also the sound of an object-based sound source. In this case, together with the bed channel processing unit 52, the speaker selection unit 13 of FIG. 11 is provided in the acoustic processing device 1.

### Example 2 of Output Control

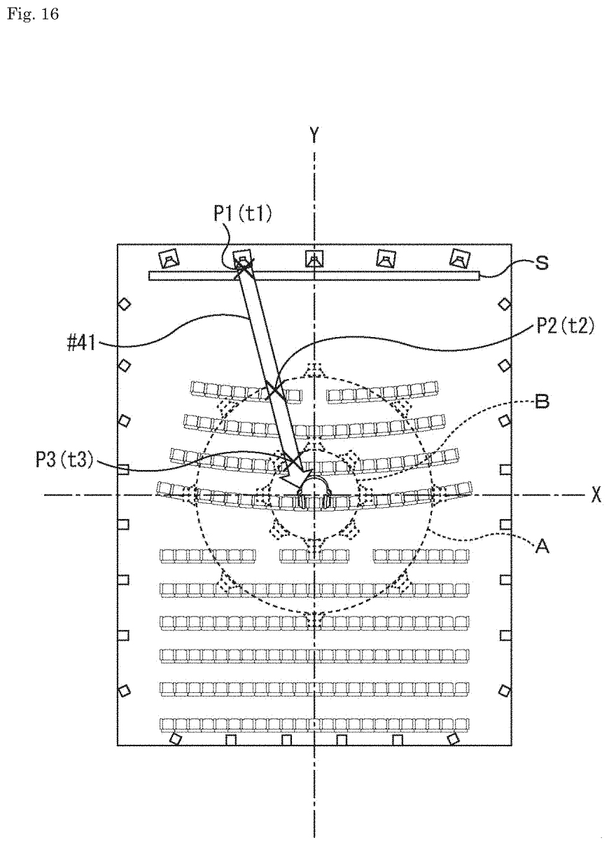

FIG. 16 is a view of an exemplary dynamic object.

Assume that a dynamic object moves from position P1 in the vicinity of the screen S toward the user seated at the origin position as indicated by the arrow #41. The track of the dynamic object that starts moving at time t1 and the HRTF layer A intersect at position P2 at time t2. The track of the dynamic object and the HRTF layer B intersect at position P3 at time t3.

When the sound source position exists near the position P1, the sound of the dynamic object to be output, the sound is heard from the real speaker located near the position P1, and when the sound source position is near position P2 or P3, the sound is mainly heard from the earphones 2.

When the sound source position exists near position P2, as for the sound of the dynamic object to be output, the sound generated by sound image localization processing using the HRTF in the HRTF layer A corresponding to position P2 is mainly heard from the earphones 2. Similarly, when the sound source position is near position P3, as for the sound of the dynamic object to be output, the sound generated by sound image localization processing using the HRTF in the HRTF layer B corresponding to position P3 is mainly heard through the earphones 2.

In this way, when reproducing the sound of a dynamic object, the device used to output the sound is switched from any of the real speakers to the earphones 2 according to the position of the dynamic object. In addition, the HRTF used for the sound image localization processing to the sound to be output from the earphones 2 is switched from an HRTF in one HRTF layer to an HRTF in another HRTF layer.

Cross-fade processing is applied to each sound in order to connect the sound before and after such switching is carried out.

FIG. 17 is a diagram of an exemplary configuration of the acoustic processing device 1.

The configuration shown in FIG. 17 is different from that in FIG. 11 in that a gain adjustment unit 61 and a gain adjustment unit 62 are provided in a stage preceding the convolution processing unit 11. An audio signal and sound source position information are supplied to the gain adjustment unit 61 and the gain adjustment unit 62.

The gain adjustment unit 61 and the gain adjustment unit 62 each adjust the gain of an audio signal according to the position of a sound source. The audio signal L having its gain adjusted by the gain adjustment unit 61 is supplied to the HRTF application unit 11L-A, and the audio signal R is supplied to the HRTF application unit 11R-A. The audio signal L having its gain adjusted by the gain adjustment unit 62 is supplied to the HRTF application unit 11L-B, and the audio signal R is supplied to the HRTF application unit 11R-B.

The convolution processing unit 11 includes the HRTF application units 11L-A and 11R-A which perform convolution processing using an HRTF in the HRTF layer A and the HRTF application units 11L-B and 11R-B which perform convolution processing using an HRTF in the HRTF layer B. The HRTF application units 11L-A and 11R-A are supplied with a coefficient for an HRTF in the HRTF layer A corresponding to a sound source position from the HRTF database 12. Similarly, The HRTF application units 11L-B and 11R-B are supplied with a coefficient for an HRTF in the HRTF layer B corresponding to a sound source position from the HRTF database 12.

The HRTF application unit 11L-A performs filtering processing to apply the HRTF in the HRTF layer A to the audio signal L supplied from the gain adjustment unit 61 and outputs the filtered audio signal L.

The HRTF application unit 11R-A performs filtering processing to apply the HRTF in the HRTF layer A supplied from the gain adjustment unit 61 to the audio signal R and outputs the filtered audio signal R.

The HRTF application unit 11L-B performs filtering processing to apply the

HRTF in the HRTF layer B to the audio signal L supplied from the gain adjustment unit 62 and outputs the filtered audio signal L.

The HRTF application unit 11R-B performs filtering processing to apply the HRTF in the HRTF layer B to the audio signal R supplied from the gain adjustment unit 62 and outputs the filtered audio signal R.

The audio signal L output from the HRTF application unit 11L-A and the audio signal L output from the HRTF application unit 11L-B are added, then supplied to the earphone output control unit 14-2 and output to the earphones 2. The audio signal R output from the HRTF application unit 11R-A and the audio signal R output from the HRTF application unit 11R-B are added, then supplied to the earphone output control unit 14-2 and output to the earphones 2.

The speaker selection unit 13 adjusts the gain of an audio signal and the volume of sound to be output from a real speaker according to the position of the sound source.

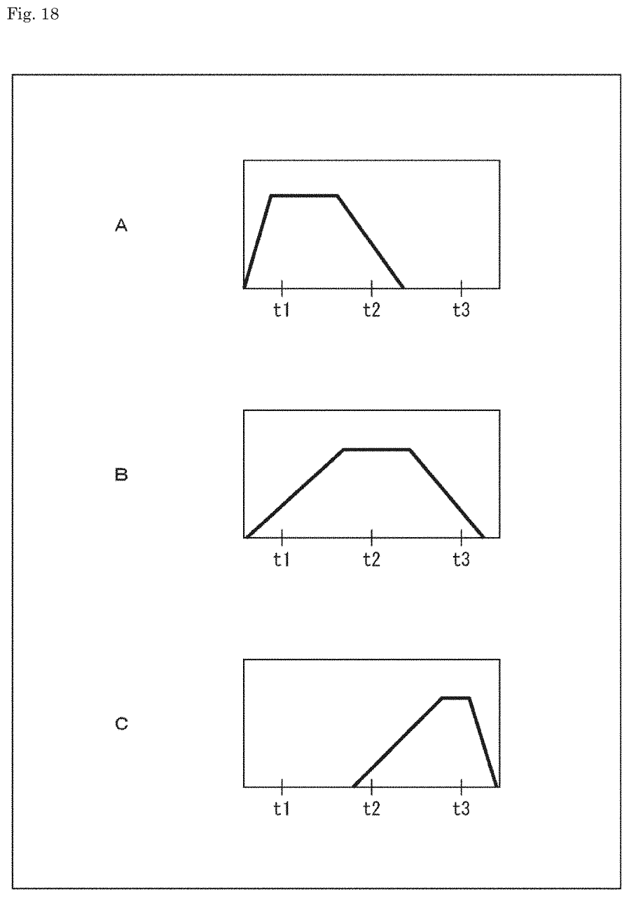

FIG. 18 illustrates examples of gain adjustment.

FIG. 18 at A shows an example of gain adjustment by the speaker selection unit 13. The gain adjustment by the speaker selection unit 13 is performed so that when an object is in the vicinity of position P1, the gain attains 100%, and the gain is gradually decreased as the object moves away from position P1.

FIG. 18 at B shows an example of gain adjustment by the gain adjustment unit 61. The gain adjustment by the gain adjustment unit 61 is performed so that the gain is increased as the object approaches position P2, and the gain attains 100% when the object is in the vicinity of position P2. As a result, the volume of the real speaker fades out and the volume of the earphones 2 fades in as the position of the object approaches from position P1 to position P2.

The gain adjustment by the gain adjustment unit 61 is performed so that the gain is gradually reduced as a function of distance from the position P2.

FIG. 18 at C shows an example of gain adjustment by the gain adjustment unit 62. The gain adjustment by the gain adjustment unit 62 is performed so that the gain is increased as the object approaches position P3, and the gain attains 100% when the object is in the vicinity of position P3. In this way, as the position of the object approaches from position P2 to position P3, the volume of the sound processed using the HRTF in the HRTF layer A and output from earphones 2 fades out and the volume of the sound processed using the HRTF in the HRTF layer B fades in.

By cross fading the sound of dynamic objects in this way, the sound before switching and the after switching can be continuous in a natural way when switching output devices or when switching between HRTFs used for sound image localization processing.

### Example 3 of Output Control

In addition to sound data and position information, size information indicating the size of a sound source may be included in the sound source information. The sound of a sound source with a large size can be reproduced by sound image localization processing using the HRTFs of multiple sound sources. For example, the sound of a large size sound source can be reproduced by sound image localization processing using the HRTFs of multiple sound sources.

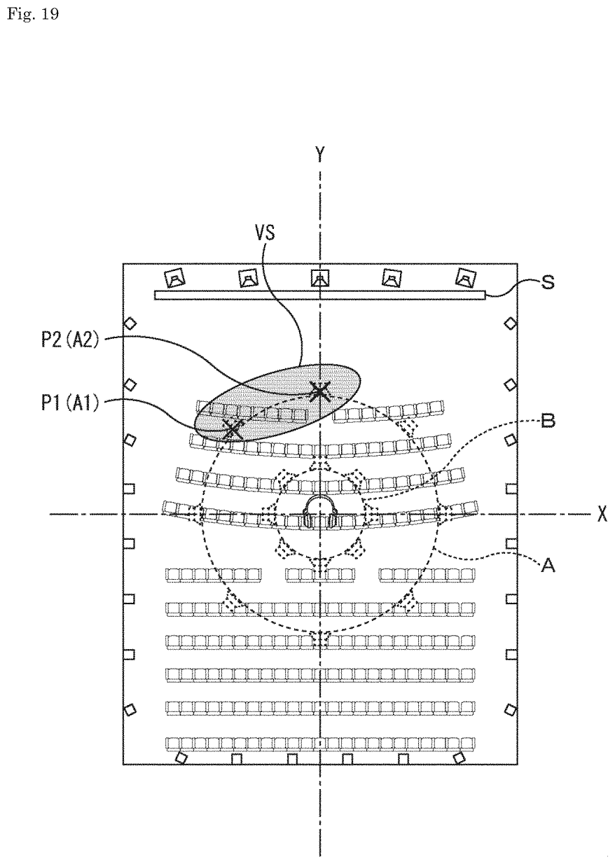

FIG. 19 is a view of exemplary sound sources.

As shown in color in FIG. 19, it is assumed that a sound source VS is set in the range including positions P1 and P2. In this case, the sound source VS is reproduced by sound image localization processing using the HRTF of a sound source A1 set at position P1 and the HRTF of a sound source A2 set at position P2 among the HRTFs in the HRTF layer A.

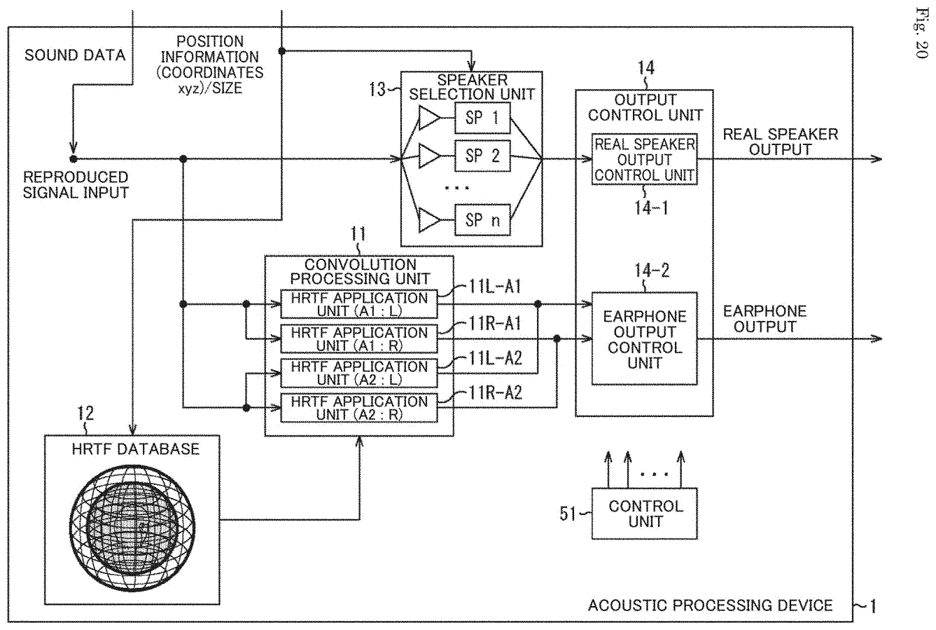

FIG. 20 is a diagram of an exemplary configuration of the acoustic processing device 1.

As shown in FIG. 20, the size information of the sound source is input to the HRTF database 12 and the speaker selection unit 13 together with the position information. The audio signal L of the sound source VS is supplied to the HRTF application unit 11L-A1 and the HRTF application unit 11L-A2, and the audio signal R is supplied to the HRTF application unit 11R-A1 and the HRTF application unit 11R-A2.

The convolution processing unit 11 includes the HRTF application unit 11L-A1 and the HRTF application unit 11R-A1 which perform convolution processing using the HRTF of the sound source A1, and the sound source HRTF application units 11L-A2 and 11R-A2 which perform convolution processing using the HRTF of the sound source A2. A coefficient for the HRTF of the sound source A1 is supplied from the HRTF database 12 to the HRTF application units 11L-A1 and 11R-A1. A coefficient for the HRTF of the sound source A2 is supplied from the HRTF database 12 to the HRTF application units 11L-A2 and 11R-A2.

The HRTF application unit 11L-A1 performs filtering processing to apply the HRTF of the sound source A1 to the audio signal L and outputs the filtered audio signal L.

The HRTF application unit 11R-A1 performs filtering processing to apply the HRTF of the sound source A1 to the audio signal R and outputs the filtered audio signal R.

The HRTF application unit 11L-A2 performs filtering processing to apply the HRTF of the sound source A2 to the audio signal L and outputs the filtered audio signal L.

The HRTF application unit 11R-A2 performs filtering processing to apply the HRTF of the sound source A2 to the audio signal R and outputs the filtered audio signal R.

The audio signal L output from the HRTF application unit 11L-A1 and the audio signal L output from the HRTF application unit 11L-A2 are added, then supplied to the earphone output control unit 14-2 and output to the earphones 2. The audio signal R output from the HRTF application unit 11R-A1 and the audio signal R output from the HRTF application unit 11R-A2 are added, then supplied to the earphone output control unit 14-2 and output to the earphones 2.

As described above, the sound of a large sound source is reproduced by sound image localization processing using the HRTFs of multiple sound sources.

The HRTFs of three or more sound sources may be used for the sound image localization processing. A dynamic object may be used to reproduce the movement of a large sound source. When a dynamic object is used, cross-fade processing as described above may be performed as appropriate.

Instead of using multiple HRTFs in the same HRTF layer, a large sound source may be reproduced by sound image localization processing using multiple HRTFs in different HRTF layers such as an HRTF in the HRTF layer A and an HRTF in the HRTF layer B.

### Example 4 of Output Control

From movie sound, high frequency sound may be output from earphones 2 and low frequency sound may be output from a real speaker.

Sound with a prescribed threshold frequency or above is output from the earphones 2 as high frequency sound, and sound with a frequency below that frequency is output from a real speaker as low frequency sound. For example, a subwoofer provided as a real speaker is used to output low frequency sound.

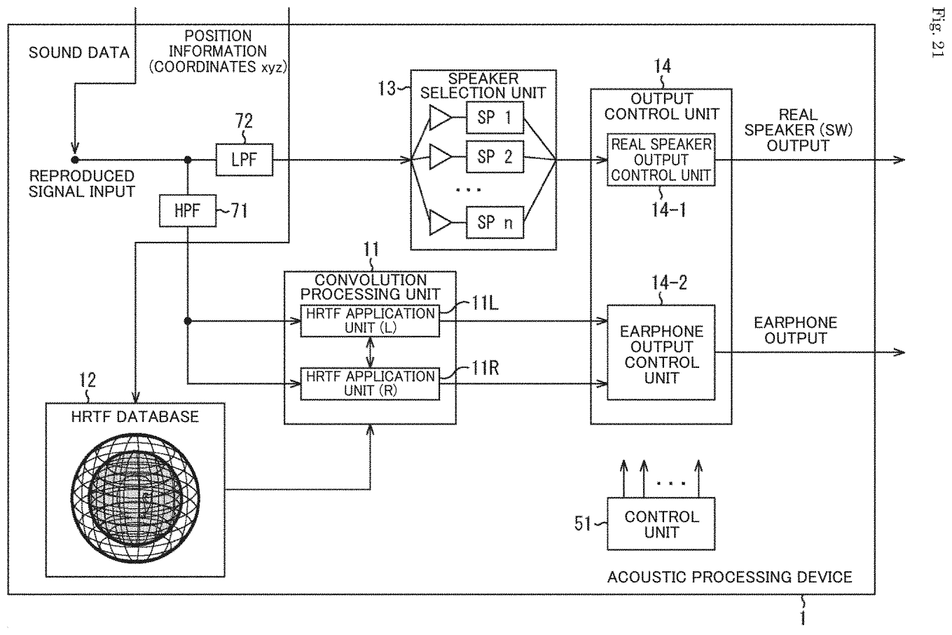

FIG. 21 is a diagram of an exemplary configuration of the acoustic processing device 1.

The configuration of the acoustic processing device 1 shown in FIG. 21 is different form the configuration in FIG. 11 in that the device includes an HPF (Hi_{g}h Pass Filter) 71 in a stage preceding the convolution processing unit 11, and an LPF (Low Pass Filter) 72 in a stage preceding the speaker selection unit 13. An audio signal is supplied to the HPF 71 and the LPF 72.

The HPF 71 extracts a high frequency sound signal from the audio signal and outputs the signal to the convolution processing unit 11.

The LPF 72 extracts a low frequency sound signal from the audio signal and outputs the signal to the speaker selection unit 13.

The convolution processing unit 11 performs the signals supplied from HPF 71 to filtering processing at the HRTF application units 11L and 11R, and outputs the filtered audio signal.

The speaker selection unit 13 assigns the signal supplied from the LPF 72 to a subwoofer and outputs the signal.

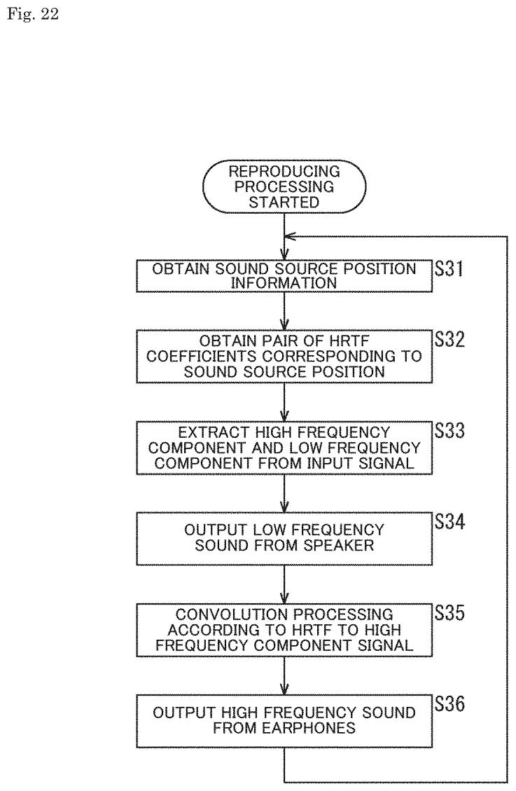

Referring to the flowchart in FIG. 22, the reproducing processing by the acoustic processing device 1 having the configuration shown in FIG. 21 will be described.

In step S31, the HRTF database 12 obtains the position information of the sound source.

In step S32, the convolution processing unit 11 acquires pairs of HRTF coefficients read from the HRTF database 12 according to the positions of the sound sources.

In step S33, the HPF 71 extracts a high frequency component signal from the audio signal. In addition, the LPF 72 extracts a low frequency component signal from the audio signal.

In step S34, the speaker selection unit 13 outputs the signal extracted by the LPF 72 to the real speaker output control unit 14-1 and causes the low frequency sound to be output from the subwoofer.

In step S35, the convolution processing unit 11 performs convolution processing on the high frequency component signal extracted by the HPF 71.

In step S36, the earphone output control unit 14-2 transmits the audio signal after the convolution processing by the convolution processing unit 11 to the earphones 2 and causes the high frequency sound to be output.

The above processing is repeated for each sample from each sound source that constitutes the audio of the movie. In the processing of each sample, the pair of HRTF coefficients is updated as appropriate according to position information on the sound sources.

### Modifications

### Exemplary Output Device

Although it is assumed that real speakers installed in a movie theater and the open-type earphones 2 are used, a hybrid type acoustic system may be implemented in a combination with any of other output devices.

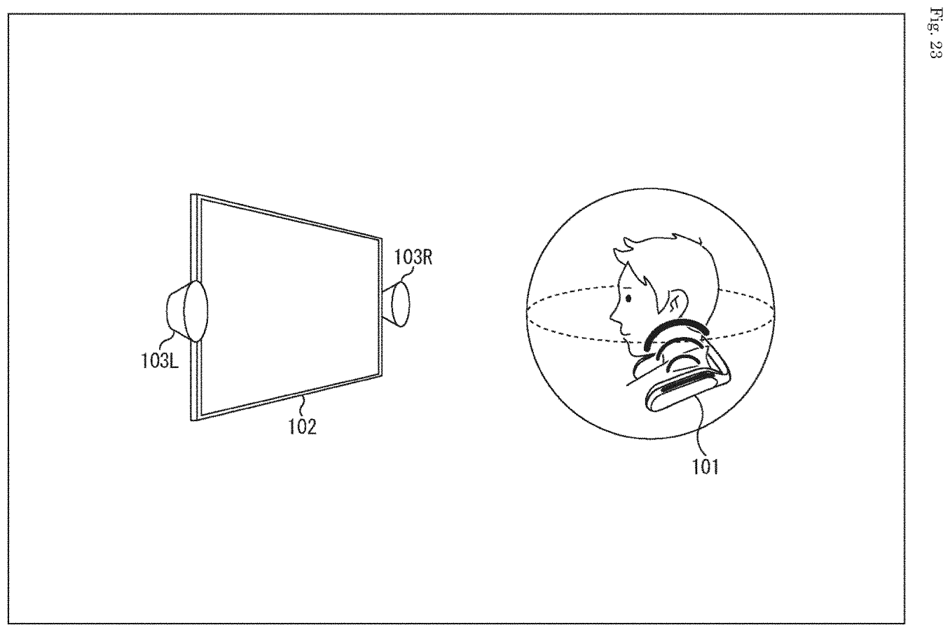

FIG. 23 is a view of an exemplary configuration of a hybrid-type acoustic system.

As shown in FIG. 23, a neckband speaker 101 and built-in speakers 103L and 103R of a TV 102 may be combined to form a hybrid-type acoustic system. The neckband speaker 101 is a shoulder-mounted output device described with reference to FIG. 4 at B.

In this case, the sound of a virtual sound source obtained by sound image localization processing based on an HRTF is output from the neckband speaker 101. Although only one HRTF layer is shown in FIG. 23, multiple HRTF layers are provided around the user.

The sound of an object-based sound source and a channel-based sound source are output from the speakers 103L and 103R as the sound of a real sound source.

In this way, various output devices that are prepared for each of users and capable of outputting sound to be heard by the user may be used as output devices for outputting the sound of a virtual sound source obtained by HRTF-based sound image localization processing.

Various output devices that are different from the real speakers installed in movie theaters may be used as output devices for outputting the sound of a real sound source. Consumer theater speakers, smart phones, and the speaker of tablets can be used to output a real sound source.

The acoustic system implemented by combining multiple types of output devices can also be a hybrid type acoustic system that allows users to hear sound customized for each user using HRTFs and common sound for all users in the same space.

Only one user may be in the space instead of multiple users as shown in FIG. 23.

The hybrid-type acoustic system may be realized using in-vehicle speakers.

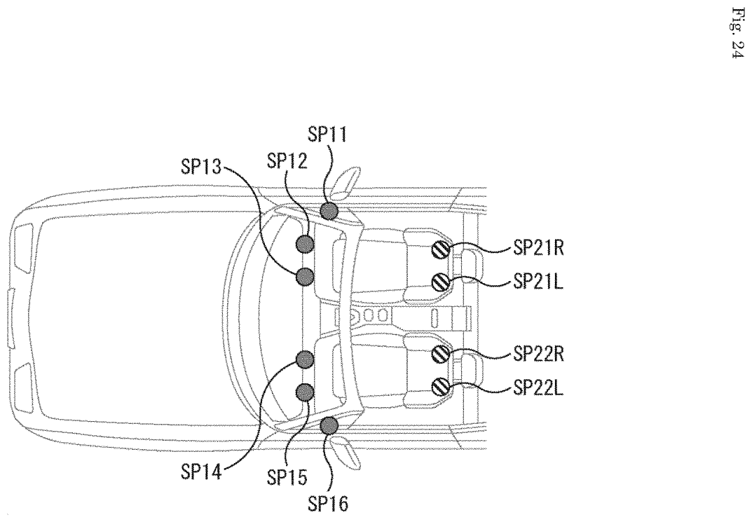

FIG. 24 shows an example of the installation position of in-vehicle speakers.

FIG. 24 shows the configuration around the driver and passenger seats of an automobile. Speakers SP11 to SP16, indicated by colored circles, are installed in various positions in the automobile, for example around the dashboard in front of the driver and front passenger seats, inside the automobile door, and inside the ceiling of the automobile.

The automobile is also provided with speakers SP21L and SP21R above the backrest of the driver's seat and speaker SP22L and speaker SP22R above the backrest of the passenger seat as indicated by the circles with hatches.

Speakers are provided at various positions in the rear of the interior of the automobile in the same manner.

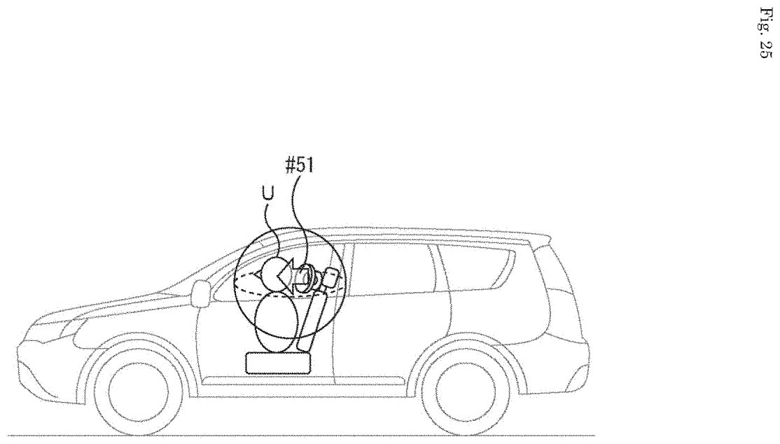

A speaker installed at each seat is used to output the sound of a virtual sound source as an output device for the user sitting in the seat. For example, the speakers SP21L and SP21R are used to output sound to be heard by the user U sitting in the driver's seat as indicated by the arrow #51 in FIG. 25. The arrow #51 indicates that the sound of the virtual sound source output from the speakers SP21L and SP21R is output toward the user U who is seated in the driver's seat. The circle surrounding the user U represents an HRTF layer. Only one HRTF layer is shown, but multiple HRTF layers are set around the user.

Similarly, speakers SP22L and SP22R are used to output sound to be heard by the user sitting in the passenger seat.

The hybrid type acoustic system may be implemented by using speakers installed at each seat for sound output from a virtual sound source and using the other speakers for the sound output from a real sound source.

The output device used for sound output from the virtual sound source can be not only the output device worn by each user, but also output devices installed around the user.

In this way, sound can be heard by the hybrid type acoustic system in various listening spaces such as a space in an automobile or a room in a house as well as in a movie theater.

### Other Examples

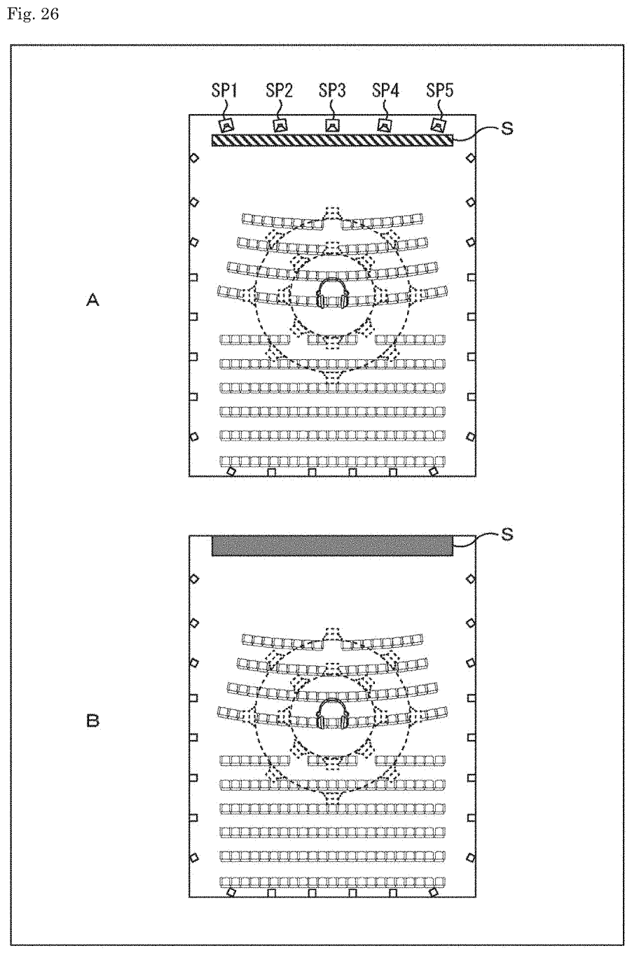

FIG. 26 is a view of an exemplary screen.

As shown in FIG. 26 at A, an acoustic transmissive screen that allows real speakers to be installed on the back side may be installed as a screen S in a movie theater or a direct-view display that does not transmit sound may be installed as shown in FIG. 26 at B.

When a display that does not transmit sound is installed as the screen S, the earphones 2 are used to output sound from a sound source such as a character's voice that exists at a position on the screen S.

The output device such as the earphones 2 used to output the sound of the virtual sound source may have a head tracking function that detects the direction of the user's face. In this case, the sound image localization processing is performed so that the position of the sound image does not change even if the direction of the user's face changes.

A HRTF layer optimized for each listener and a common HRTF (a standard HRTF) layer may be provided as the HRTF layers. HRTF optimization is carried out by taking a photograph of the listener's ears with a camera and adjusting the standard HRTF on the basis of the result of analysis of the captured image.

When HRTF optimization is performed, only HRTFs in a given direction, such as forward, may be optimized. This enables the memory required for processing using HRTFs to be reduced.

The rear reverberation of the HRTF may be matched with the reverberation of the movie theater to acclimate the sound. As the rear reverberation of the HRTF, reverberation with the audience in the theater and reverberation without the audience in the theater.

The above mentioned feature can be applied to production sites for various contents such as movies, music, and games.

### Exemplary Computer Configuration

The series of processing steps described above can be executed by hardware or software. When the series of processing steps are executed by software, a program that constitutes the software is installed from a program recording medium on a computer built in dedicated hardware or a general-purpose personal computer. The above-mentioned series of processes can be executed by hardware or software.

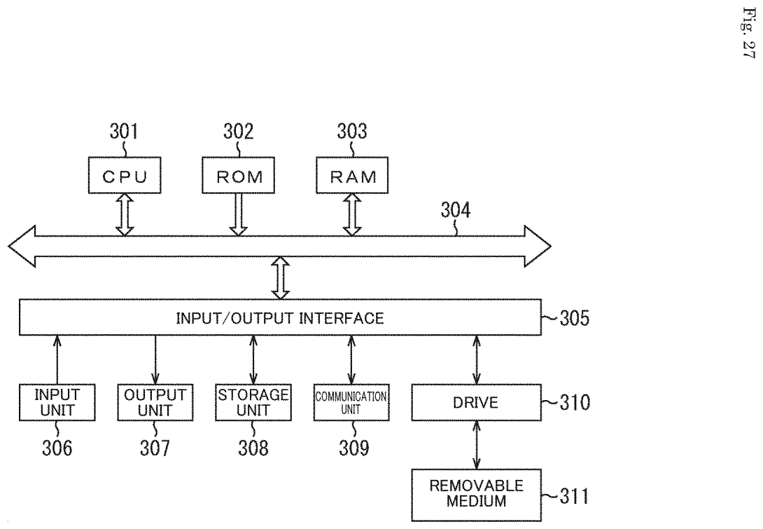

FIG. 27 is a block diagram of an exemplary configuration of computer hardware that executes the above-described series of processing steps using a program.

The acoustic processing device 1 is implemented by the computer with the configuration as shown in FIG. 27. The functional parts of the acoustic processing device 1 may be realized by multiple computers. For example, the functional part that controls output of sound to real speakers and the functional part that controls output of sound to the earphones 2 may be realized on different computers.

A CPU (Central Processing Unit) 301, a read-only memory (ROM) 302, and a random access memory (RAM) 303 are connected with one another by a bus 304.

An input/output interface 305 is further connected to the bus 304. An input unit 306 including a keyboard and a mouse and an output unit 307 including a display and a speaker are connected to the input/output interface 305. In addition, a storage unit 308 including a hard disk or a nonvolatile memory, a communication unit 309 including a network interface, a drive 310 driving a removable medium 311 are connected to the input/output interface 305.

In the computer having the above-described configuration, for example, the CPU 301 loads a program stored in the storage unit 308 into the RAM 303 via the input/output interface 305 and the bus 304 and executes the program to perform the series of processing steps described above.

The program executed by the CPU 301 is recorded on, for example, a removable medium 311 or is provided via a wired or wireless transfer medium such as a local area network, the Internet, or a digital broadcast to be installed in the storage unit 308.

The program executed by the computer may be a program that performs a plurality of steps of processing in time series in the order described in the present specification or may be a program that performs a plurality of steps of processing in parallel or at a necessary timing such as when a call is made.

In the present specification, a system is a collection of a plurality of constituent elements (devices, modules (components), or the like) and all the constituent elements may be located or not located in the same casing. Accordingly, a plurality of devices stored in separate casings and connected via a network and a single device in which a plurality of modules are stored in one casing are all systems.

The effects described in the present specification are merely examples and are not intended as limiting, and other effects may be obtained.

The embodiments of the present feature are not limited to the aforementioned embodiments, and various changes can be made without departing from the gist of the present feature.

For example, the present technique may be configured as cloud computing in which a plurality of devices share and cooperatively process one function via a network.

In addition, each step described in the above flowchart can be executed by one device or executed in a shared manner by a plurality of devices.

Furthermore, in a case in which one step includes a plurality of processes, the plurality of processes included in the one step can be executed by one device or executed in a shared manner by a plurality of devices.

### Combination Examples of Components

The present feature may be configured as follows.

(1) An information processing device including an output control unit configured to cause a speaker provided in a listening space to output sound of a prescribed sound source which constitutes audio of a content and an output device for each listener to output sound of a virtual sound source different from the prescribed sound source, wherein the sound of the virtual sound source is generated by processing using a transfer function corresponding to a sound source position.

(2) The information processing device according to (1), wherein the output control unit causes headphones as the output device worn by each listener to output the sound of the virtual sound source, wherein the headphones can capture outside sound.

(3) The information processing device according to (2), wherein the content includes video image data and sound data, and

the output control unit causes the headphones to output the sound of the virtual sound source having a sound source position within a prescribed range from the position of a character included in the video image.

(4) The information processing device according to (2), wherein the output control unit causes the speaker to output channel-based sound and the headphones to output object-based sound of the virtual sound source.

(5) The information processing device according to (2), wherein the output control unit causes the speaker to output sound of a static object and the headphones to output sound of the virtual sound source of a dynamic object.

(6) The information processing device according to (2), wherein the output control unit causes the speaker to output common sound to be heard by a plurality of the listeners and the headphones to output sound to be heard by each of the listeners while changing the direction of a sound source depending on the position of the listener.

(7) The information processing device according to (2), wherein the output control unit causes the speaker to output sound having a sound source position at a height equal to the height of the speaker and the headphones to output sound of the virtual sound source having a sound source position at a height different from the height of the speaker.

(8) The information processing device according to (2), wherein the output control unit causes the headphones to output sound of the virtual sound source having a sound source position apart from the speaker.

(9) The information processing device according to any one of (1) to (8), wherein a plurality of the virtual sound sources are arranged so that the virtual sound sources are in multiple layers at the same distance from a reference position as a center,

the information processing device further including a storage unit that stores information about the transfer function corresponding to the reference position in each of the virtual sound sources.

(10) The information processing device according to (9), wherein the layers of the virtual sound sources are provided by arranging the plurality of virtual sound sources in a full sphere shape.

(11) The information processing device according to (9) or (10), wherein the virtual sound sources in the same layer are equally spaced.

(12) The information processing device according to any one of (9) to (11), wherein the plurality of layers of the virtual sound sources include a layer of the virtual sound sources each having the transfer function adjusted for each of the listeners.

(13) The information processing device according to any one of (9) to (12), further including a sound image localization processing unit which applies the transfer function to an audio signal as a processing target and generates sound of the virtual sound source.

(14) The information processing device according to (13), wherein the sound image localization processing unit switches sound to be output from the output device from sound of the virtual sound source in a prescribed layer to sound of the virtual sound source in another layer.

(15) The information processing device according to (14), wherein the output control unit causes the output device to output the sound of the virtual sound source in the prescribed layer and the sound of the virtual sound source in the other layer generated on the basis of the audio signal having a gain adjusted.

(16) An output control method causing an information processing device to: cause a speaker provided in a listening space to output sound of a prescribed sound source which constitutes audio of a content; and

cause an output device for each listener to output sound of a virtual sound source different from the prescribed sound source, wherein the sound of the virtual sound source is generated by processing using a transfer function corresponding to a sound source position.

(17) A program causing a computer to execute processing of:

causing a speaker provided in a listening space to output sound of a prescribed sound source which constitutes audio of a content; and

causing an output device for each listener to output sound of a virtual sound source different from the prescribed sound source, wherein the sound of the virtual sound source is generated by processing using a transfer function corresponding to a sound source position.

### REFERENCE SIGNS LIST

1 Acoustic processing device

2 Earphone

11 Convolution processing unit

12 HRTF database

13 Speaker selection unit

14 Output control unit

51 Control unit

52 Bed channel processing unit

61, 62 Gain adjusting unit

71 HPF

72 LPF

1. An information processing device comprising an output control unit configured to cause a speaker provided in a listening space to output sound of a prescribed sound source which constitutes audio of a content and an output device for each listener to output sound of a virtual sound source different from the prescribed sound source, wherein the sound of the virtual sound source is generated by processing using a transfer function corresponding to a sound source position.

2. The information processing device according to claim 1, wherein the output control unit causes headphones as the output device worn by each listener to output the sound of the virtual sound source, wherein the headphones can capture outside sound.

3. The information processing device according to claim 2, wherein the content includes video image data and sound data, and
the output control unit causes the headphones to output the sound of the virtual sound source having a sound source position within a prescribed range from the position of a character included in the video image.

4. The information processing device according to claim 2, wherein the output control unit causes the speaker to output channel-based sound and the headphones to output object-based sound of the virtual sound source.

5. The information processing device according to claim 2, wherein the output control unit causes the speaker to output sound of a static object and the headphones to output sound of the virtual sound source of a dynamic object.

6. The information processing device according to claim 2, wherein the output control unit causes the speaker to output common sound to be heard by a plurality of the listeners and the headphones to output sound to be heard by each of the listeners while changing the direction of a sound source depending on the position of the listener.

7. The information processing device according to claim 2, wherein the output control unit causes the speaker to output sound having a sound source position at a height equal to the height of the speaker and the headphones to output sound of the virtual sound source having a sound source position at a height different from the height of the speaker.

8. The information processing device according to claim 2, wherein the output control unit causes the headphones to output sound of the virtual sound source having a sound source position apart from the speaker.

9. The information processing device according to claim 1, wherein a plurality of the virtual sound sources are arranged so that the virtual sound sources are in multiple layers at the same distance from a reference position as a center,
the information processing device further comprising a storage unit that stores information about the transfer function corresponding to the reference position in each of the virtual sound sources.

10. The information processing device according to claim 9, wherein the layers of the virtual sound sources are provided by arranging the plurality of virtual sound sources in a full sphere shape.

11. The information processing device according to claim 9, wherein the virtual sound sources in the same layer are equally spaced.

12. The information processing device according to claim 9, wherein the plurality of layers of the virtual sound sources include a layer of the virtual sound sources each having the transfer function adjusted for each of the listeners.

13. The information processing device according to claim 9, further comprising a sound image localization processing unit which applies the transfer function to an audio signal as a processing target and generates sound of the virtual sound source.

14. The information processing device according to claim 13, wherein the sound image localization processing unit switches sound to be output from the output device from sound of the virtual sound source in a prescribed layer to sound of the virtual sound source in another layer.

15. The information processing device according to claim 14, wherein the output control unit causes the output device to output the sound of the virtual sound source in the prescribed layer and the sound of the virtual sound source in the other layer generated on the basis of the audio signal having a gain adjusted.

16. An output control method causing an information processing device to:
cause a speaker provided in a listening space to output sound of a prescribed sound source which constitutes audio of a content; and
cause an output device for each listener to output sound of a virtual sound source different from the prescribed sound source, wherein the sound of the virtual sound source is generated by processing using a transfer function corresponding to a sound source position.

17. A program causing a computer to execute processing of:
causing a speaker provided in a listening space to output sound of a prescribed sound source which constitutes audio of a content; and
causing an output device for each listener to output sound of a virtual sound source different from the prescribed sound source, wherein the sound of the virtual sound source is generated by processing using a transfer function corresponding to a sound source position.
